(19) United States
(12) Patent Application Publication
(10) Pub. No.: US 2023/0396078 A1
(43) Pub. Date: Dec. 7, 2023

(54) TRANSFER UNIT, SYSTEM AND METHOD FOR PERFORMING AN INTRA-BATTERY EQUALIZATION PROCESS

(71) Applicant: SMA Solar Technology AG, Niestetal (DE)

(72) Inventors: Claus Allert, Kaufungen (DE); Aleksandra-Sasa Bukvic-Schäfer, Kassel (DE)

(21) Appl. No.: 18/452,593

(22) Filed: Aug. 21, 2023

Related U.S. Application Data
(63) Continuation of application No. PCT/EP2022/053857, filed on Feb. 16, 2022.

(30) Foreign Application Priority Data
Feb. 23, 2021 (DE) 10 2021 104 236.4

(51) Int. Cl. H02J 7/00; H01M 10/42; H01M 10/44

(52) U.S. Cl. CPC H02J 7/0014; H02J 7/00032; H02J 7/0048; H01M 10/425; H01M 10/441; H02J 2207/20; H01M 2010/4271

(57) ABSTRACT

The application describes a transfer circuit or system with a first DC bus for connecting a plurality of battery racks to an inverter bridge for a first power exchange with an AC grid. The transfer circuit or system has a second DC bus which is connected to the first DC bus via a DC/DC converter. The transfer circuit or system is arranged to disconnect at least one battery rack of the plurality of battery racks from the first DC bus and to connect it to the second DC bus for performing an intra-battery equalization process. The application also describes a system with a transfer unit and a method for performing an intra-battery equalization process.

### REFERENCE TO RELATED APPLICATIONS

This application is a Continuation of International Application number PCT/EP2022/053857, filed on Feb. 16, 2022, which claims the benefit of German Application number 10 2021 104 236.4, filed on Feb. 23, 2021. The contents of the above-referenced patent applications are hereby incorporated by reference in their entirety.

### FIELD

In a battery inverter system, a plurality of battery racks may be connected to an inverter bridge via a first DC bus.

### BACKGROUND

Battery inverter systems can comprise a number of battery racks connected in parallel via a DC bus, which can exchange power with a connected AC grid via an inverter bridge. A battery rack refers to an arrangement of individual cells or cell sections—also called a module or pack—that are connected in series and optionally also in parallel, and can optionally be managed by a battery management system. Inverter bridges may be included in inverters that can be used in battery inverter systems as both grid-forming and grid-guided inverters. Cell sections may have multiple cells that may be connected in series and/or parallel within the cell section.

In the course of operation, differences in the state of charge between the cells or between cell sections of a battery rack occur due to cyclical charging and discharging of the cells, so that an equalization process must occasionally be initiated in order to balance the states of charge of the cells again, or to be able to estimate the state of charge more accurately.

It is possible to remove the affected battery rack from the parallel connection of the battery racks to the DC bus during such an equalization process. Then the capacity of the battery rack is not available for the system. At the end of the equalization process, the battery rack concerned has a state of charge that differs from the state of charge of the other racks. A direct connection of this battery rack to the DC bus with the other battery racks should therefore be avoided because of the equalization currents that occur in this case. It is therefore advantageous to balance the state of charge of the battery rack concerned to the state of charge of the other battery racks before it is again connected in parallel with the other battery racks on the DC bus. Such a balancing process concerns the balancing of states of charge between different battery racks. An equalization process concerns the intra-battery equalization process of charge states of cells or cell sections of a battery rack. After an intra-battery equalization process, a balancing process to the state of charge of the other battery racks and a subsequent connection to the DC bus, the battery rack is operationally available again.

It is conceivable to couple battery racks to a DC bus, each via its own DC/DC converter.

It is possible to disconnect a battery rack that needs equalizing, wait until the battery management system of the battery racks has carried out the intra-battery equalization, for example, and adjust the state of charge of the remaining battery racks to the state of charge of the equalized battery rack as part of the system's operational management, and then reconnect the disconnected battery rack. Here, a system with reduced capacity is available for a period of time.

It is still possible to take the entire system out of operation for internal equalization process of the battery racks. In this case, redundant systems can be provided to ensure the operation of the system.

Such procedures are described in US 2011/0127964 A1, in which a plurality of battery units can be connected to a power converter either via switches or via voltage converters. To carry out an equalization process between cells of the battery units, these are temporarily disconnected from the power converter by opening the corresponding switch or the voltage converter prevents a current flow.

In some cases, it is useful or even necessary to supply additional energy to the battery rack for the equalization process, for example, to fully charge all cells and to carry out the equalization process. In this case, it is not sufficient to remove a battery rack from the array, but energy must be actively supplied through the inverter bridge. This can be done for an entire array or, alternatively, for a part of the battery system. In both cases, the inverter bridge or the inverter is not available for regular operation of the battery inverter system.

### SUMMARY

Thus, it is an aspect of the disclosure to disclose a transfer circuit that can be used to create a battery inverter system with a plurality of battery racks, in which an equalization process of the battery racks can be realized with the least possible impact on the capacity of the provision of power in both directions. Further aspects of the disclosure relate to a system or method for performing an equalization process with the aim of having a low impact on the power provision capacity.

In this application, the abbreviation DC (direct current) stands for direct current or direct voltage and AC (alternating current) for alternating current or alternating voltage.

A transfer unit for a battery inverter system is described. The transfer circuit or system has a first DC bus via which a plurality of battery racks can be connected to an inverter bridge for a first power exchange with an AC grid. The transfer circuit or system further comprises a second DC bus which is connected to the first DC bus via a DC/DC converter, wherein the DC/DC converter has a rated power which is at least a factor of 5 lower than the rated power of the inverter bridge. The transfer circuit or system is arranged to disconnect at least one battery rack of the plurality of battery racks from the first DC bus and to connect it (i.e., the at least one battery rack) to the second DC bus for performing an intra-battery equalization process. A battery rack may comprise multiple cells or cell sections, which may be connected in series or in parallel.

The transfer circuit or system thus has two separate DC buses for battery racks. The battery racks connected to the first DC bus can thereby secure the operation, the first DC bus serves as a so-called main bus. A battery rack or a few battery racks can be temporarily coupled to the second DC bus, for example, for the purpose of intra-battery equalizing, the second DC bus serves as a so-called secondary rail. The first DC bus and the second DC bus each have a DC+ and a DC− conductor. Optionally, the first DC bus and the second DC bus can share one of the conductors, the DC+ or the DC− conductor.

The inverter bridge of an inverter is configured to be connected to and cooperate with the transfer circuit or system. The transfer circuit or system and the inverter bridge are configured to interact with each other for the first power exchange. The power exchanged via the DC/DC converter is small compared to the power exchanged via the inverter bridge. A DC/DC converter with a relatively small nominal power may be sufficient. A maximum of 20% of the nominal power of the inverter bridge can be provided in one embodiment. This may be provided, for example, for a system with ten battery racks, which should allow simultaneous equalizing of two battery racks on the second DC bus. In other words, the ratio between the rated power of the DC/DC converter and the rated power of the inverter bridge may be chosen to be less than or equal to the ratio between the number of battery racks that can be simultaneously connected to the second DC bus and the total number of battery racks. Alternatively, the ratio between the nominal power of the DC/DC converter and the nominal power of the inverter bridge can be chosen to be less than or equal to the reciprocal of the total number of battery racks. The DC/DC converter can be bidirectional in one embodiment. With a higher number of battery racks in the system, a low nominal power of the DC/DC converter may be required.

This makes it possible, in one embodiment, to connect the battery racks to the first or second DC bus without having to provide a DC/DC converter between the battery rack and the DC bus or to use battery racks with integrated DC/DC converters. Costs can be saved by using converter-free battery racks.

According to the disclosure, the transfer circuit or system comprises a control circuit which is configured to disconnect at least one battery rack of the plurality of battery racks from the first DC bus and to connect it to the second DC bus via a switching circuit in order to perform the intra-battery equalization process. The control circuit is further configured to initiate the intra-battery equalization process after connecting the at least one battery rack to the second DC bus, wherein during and/or after the intra-battery equalization process a second power exchange takes place between the first DC bus and the second DC bus via the DC-DC converter in order to achieve balancing of the state of charge of the at least one battery rack with the state of charge of the battery racks connected to the first DC bus and to supply any additional energy required for this balancing process. The control circuit is further configured to disconnect the at least one battery rack from the second DC bus and to connect it back to the first DC bus via a switching circuit after the state of charge has been balanced.

In one embodiment, the control circuit is configured to determine or receive notification of a need for the at least one battery rack to perform the equalization process. In one embodiment, a battery rack has a battery management circuit that can determine the need to perform the equalization process and can transmit a notification thereof to the control circuit of the transfer circuit or system. Alternatively or additionally, the control circuit can take over tasks of a battery management circuit and, for example, determine the need to perform the equalization process. In doing so, a forecast for a temporal course of the first power exchange can be taken into account, for example, in order to bring forward a need for carrying out the equalization process or to postpone it to a later point in time. Battery management can also be performed centrally for all racks or in stages, with individual battery management for each rack and higher-level battery management for the battery system.

A system comprises a plurality of converter-free battery racks and a transfer circuit or system, wherein the plurality of battery racks are connectable via the first DC bus to the inverter bridge for first power exchange with an AC grid. In such a system, which may, for example, be a battery inverter system, there are two separate DC buses for battery racks. The first DC bus can, for example, serve as the main bus and, for example, protect the operation. The second DC bus can, for example, serve as a secondary bus to which one or a few battery racks can be temporarily coupled for the purpose of intra-battery equalizing. A DC/DC converter allows a targeted second power exchange between the DC buses, which can serve several purposes depending on the situation.

In a method for performing an intra-battery equalization process, the state of charge of cell sections of at least one battery rack in a system with a transfer circuit or system is balanced. The at least one battery rack is disconnected from the first DC bus and connected to the second DC bus. After connecting the at least one battery rack to the second DC bus, the intra-battery equalization process is initiated with the other battery racks still connected to the first DC bus. During or after the intra-battery equalization process, a second power exchange takes place between the first DC bus and the second DC bus via the DC-DC converter in order to achieve a balancing of the state of charge of the at least one battery rack connected to the second DC bus with the state of charge of the battery racks connected to the first DC bus, and to supply energy necessary for the balancing process, wherein after the balancing of the state of charge, the at least one battery rack is disconnected from the second DC bus and is connected to the first DC bus. In one embodiment, the procedure is carried out individually for at least one battery rack.

In one embodiment, the method is performed for each of the plurality of battery racks in turn. The procedure can be carried out for individual battery racks or in groups. In this way, all battery racks of the plurality of battery racks can be balanced in their internal battery state of charge and then be balanced to the state of charge of the other battery racks. This can enable the continuous operational readiness of the system.

In one embodiment of the method, the second power exchange is at least temporarily selected to accelerate the equalization process. It enables a faster equalization process and a faster readiness for operation of the at least one battery rack again. This embodiment may be combined, for example, with an embodiment of the method in which the second power exchange occurs at least temporarily during the equalization process. In this embodiment, the equalization process then takes place during the second power exchange between the first and second DC buses via the DC/DC converter, and thus the equalization process and the second power exchange can be coordinated with each other.

In one embodiment of the method, the second power exchange occurs at least intermittently in a manner that supports the first power exchange of the system with the AC grid. For example, the equalization process may be interrupted or slowed down to maintain the first power exchange with the AC grid. This can be beneficial, for example, if the battery racks connected to the first DC bus cannot fully provide the power required for the first power exchange.

In one embodiment of the method, the second power exchange is selected as a function of the first power exchange via the inverter bridge in such a way that completion of the balancing of the state of charge of the at least one battery rack with the battery racks connected to the first DC bus is made possible at the time of completion of the equalization process or as shortly as possible thereafter. In this way, the equalization process and the balancing process can be coordinated with each other, or at best even synchronized, so that the time period in which the at least one battery rack is not available is kept as short as possible.

The initiative to start an equalization process can come from the battery management circuit of the at least one battery rack or from the control circuit of the transfer circuit or system. Further instances can be provided that release the initiation of the equalization process. Such a further instance can, for example, be a control circuit of a higher-level system to which the battery inverter system is assigned.

In one embodiment of the method, the at least one battery rack independently detects a need to perform the equalization process and communicates this to the control circuit. The detection may be performed, for example, by the battery management circuit. In one embodiment of the method, the communicated need comprises information on the urgency of performing the equalization process. An urgency may, for example, be related to an overall particularly low state of charge of the at least one battery rack or, for example, to particularly large imbalances of charges of cell sections of the at least one battery rack. For example, the course of charge-discharge cycles of the at least one battery rack can be taken into account. The history taken into account may be, for example, a specific past history and/or an expected course of a specific battery rack type.

In one embodiment of the method, the control circuit of the transfer circuit or system detects a suitable time to perform the equalization process and initiates the equalization process at this time. The detection process can, for example, take into account the urgency communicated by the individual battery racks and/or the capacity of the individual battery racks. Here, both a course of charge-discharge cycles of individual battery racks and/or several battery racks can be taken into account. Alternatively or additionally, the current or predicted operating situation of the battery inverter system and/or a higher-level system can be taken into account.

In one embodiment, the battery management circuit of the at least one battery rack controls the operation of the equalization process and communicates directly or indirectly with the control circuit of the transfer circuit or system and/or a controller of the DC/DC converter to provide a desired converter power to support the equalization process.

In one embodiment, battery racks from different first DC buses can be switched to a common second DC bus. This is conceivable, for example, for an inverter with 3 inverter bridges, in which each inverter bridge can be connected to a respective first DC bus. The transfer circuit or system can then, for example, connect the second DC bus to one of the first buses respectively via the DC/DC converter. The connection can be permanent or switchable between different first DC buses, or the second DC bus can be connected to several or all of the first DC buses via individual converters. The power exchanged via the DC/DC converter is low compared to the power exchanged via the inverter.

The method thus allows different purposes to be pursued at different stages after or during the equalization process. For example, an accelerated balancing of the state of charge between the battery racks of the two buses can be enabled in order to be able to reconnect the at least one battery rack more quickly. It is possible to abort, interrupt or delay the equalization process if the operating situation requires a power demand that the battery racks of the first bus cannot fully provide. In this case, the required power demand is taken from, or supplied to, the battery rack by the DC/DC converter. After the end of this operating situation, the equalization process can be resumed.

### BRIEF DESCRIPTION OF THE FIGURES

In the following, the disclosure is illustrated with the aid of figures, of which

FIG. 1 shows an example of a system with a transfer circuit or system, and

FIG. 2 shows a method for performing an intra-battery equalization process, for example, using the transfer circuit or system of FIG. 1.

### DETAILED DESCRIPTION

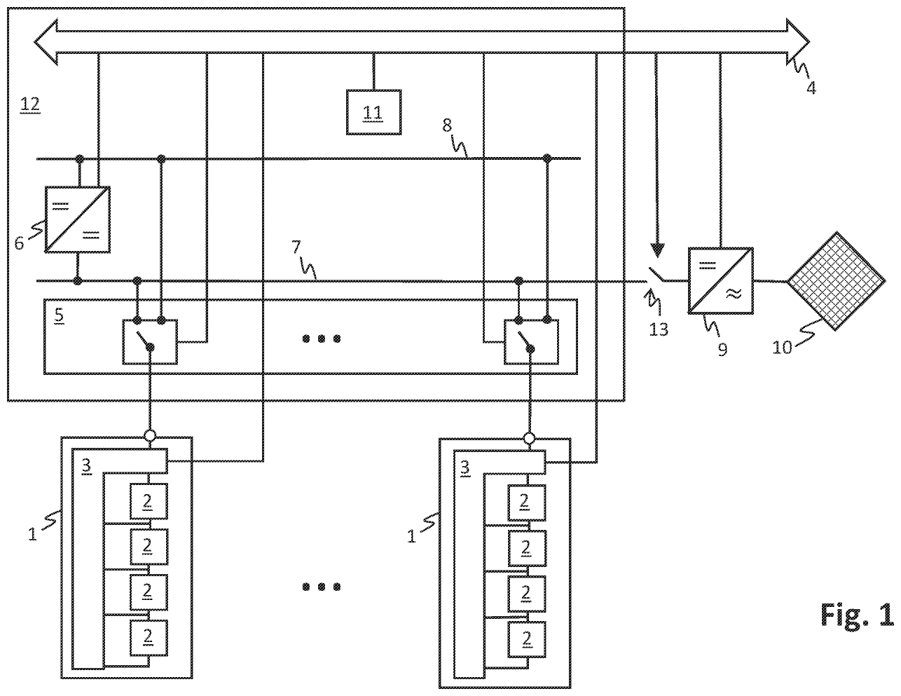

FIG. 1 shows an embodiment of a battery inverter system with a transfer circuit or system 12. The transfer circuit or system 12 has a first DC bus 7 and a second DC bus 8. FIG. 1 shows one conductor of each of the two conductors of each DC bus. It is possible that the first DC bus 7 and the second DC bus 8 share a common second conductor (not shown). The transfer circuit or system 12 comprises a DC/DC converter 6 connected between and arranged to transfer power between the first DC bus 7 and the second DC bus 8. The power transfer via the DC/DC converter 6 can be bidirectional. A plurality of battery racks 1 can be connected to the transfer circuit or system 12 via a switching circuit 5 comprising a plurality of switches. The battery racks 1 are connected in parallel to each other via the first DC bus 7. Each battery rack 1 has a plurality of cell sections 2 and optionally a battery management circuit or system 3. The cell sections 2 of a battery rack 1 are connected in series. The battery management circuit or system 3 manages the cell sections 2 and controls, for example, charging and/or discharging processes. Cell sections 2 may comprise several cells, which may be connected in series and/or parallel within the cell section 2.

An inverter bridge circuit 9 can be connected to the first DC bus 7 of the transfer circuit or system 12, via which electrical power can be exchanged with an AC network 10 such as an AC grid. The inverter bridge 9 can be integrated in an inverter which can be operated in grid-forming and/or grid-operated mode. The transfer circuit or system 12 may be disconnected from the inverter bridge 9 by a disconnect switch 13. The power exchange of the transfer circuit or system 12 with the AC grid 10 via the inverter bridge 9 can be bidirectional, so that the battery racks 1 connected to the transfer circuit or switch 12 can be charged with electrical power from the AC grid 10 via the inverter bridge 9 and/or can feed electrical power into the AC grid 10 via the inverter bridge 9.

There is a communication link between the battery management circuits or systems 3, the switches of the switching circuit 5, the DC/DC converter 6, an optional control circuit 11, the disconnector switch 13 and the inverter bridge. The communication link can, for example, be a communication bus 4 as shown in FIG. 1. Other communication connections, wired and/or wireless, are possible.

During operation of battery racks 1, differences in the state of charge between the cells or between the cell sections 2 of a battery rack 1 may occur, for example, due to cyclical charging and discharging of the cells. This may require an equalization process in which the states of charge of the cells are balanced again. Such equalization processes can take place approximately once a week, for example. Otherwise, the estimation of the currently available energy in the form of the battery state of charge could become increasingly inaccurate over time and make further operation difficult or only allow it with uncertainties about availability. In addition, there could be a risk of premature ageing of cells or cell sections 2.

In one embodiment, the battery management circuits or systems 3 may be configured to detect and/or perform an equalizing demand of the associated battery rack 1. Based on the detected need, an affected battery rack 1 can be disconnected from the first DC bus 7 by the switching circuit 5 and connected to the second DC bus 8. The battery management circuit or system 3 can start and perform the intra-battery equalization process within the affected battery rack 1. In this process, the states of charge of the individual cell sections 2 are balanced with each other. During the equalization process and/or afterwards, a power exchange with the first DC bus 7 can take place via the DC/DC converter 6 in order to balance the state of charge of the affected battery rack 1 connected to the second DC bus 8 with the state of charge of those battery racks 1 connected to the first DC bus 7 as well as to supply any energy required for the balancing process. In one embodiment, the nominal power of the DC/DC converter 6 can be considerably lower than the nominal power of the inverter bridge 9 and, for example, only up to 20% of the same. After the balancing process and the power exchange process have been carried out, the affected battery rack 1 can be disconnected again from the second DC bus 8 via the switching circuit 5 and connected to the first DC bus 7.

The optional control circuit 11 can be provided to receive an equalization demand signal in response to such demand being detected by the battery management systems 3. The equalization demand signal is received via the communication bus 4 and in turn disconnects the affected battery rack 1 from the first DC bus 7 via the switching circuit 5 and connects the affected battery rack 1 to the second DC bus 8. The equalization process and the balancing process can also be coordinated with each other via the control circuit 11. For this purpose, the control circuit 11 can be connected to the switching circuit 5 and the DC/DC converter 6 via the communication bus 4 and control them. After the equalization process and the balancing process have been carried out, the control circuit 11 can cause affected the battery rack 1 to be disconnected again from the second DC bus 8 via the switching circuit 5 and to be re-connected to the first DC bus 7. Optionally, the inverter bridge 9 and/or the disconnector switch 13 can also be connected to the communication bus 4.

At the end of the equalization process, the affected battery rack 1 may have a state of charge that differs from the state of charge of the other battery racks 1. A direct connection of this battery rack 1 to the first DC bus 7 with the other battery racks 1 should therefore be avoided because of the equalization currents that then occur. It is therefore advantageous in one embodiment to balance the state of charge of the affected battery rack 1 to the state of charge of the other battery racks 1 in a balancing process via a power exchange via the DC/DC converter 6 before it is disconnected again from the second DC bus 8 and re-connected to the first DC bus 7 in parallel with the other battery racks 1. Such a balancing process concerns the balancing of the state of charge between different battery racks 1, i.e. the DC voltages.

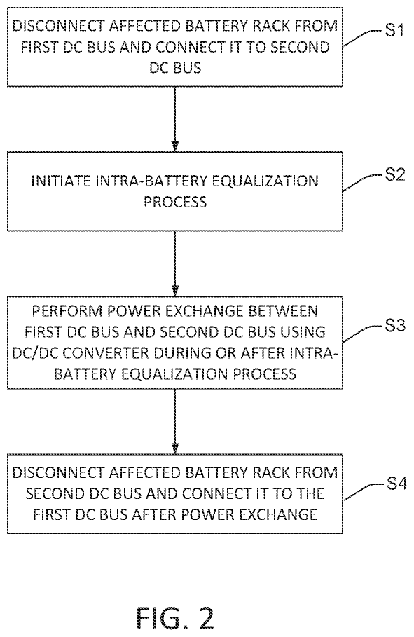

FIG. 2 shows an example of a method for carrying out an intra-battery equalization process in which the state of charge of cell sections 2 of at least one battery rack 1 can be balanced, for example, in a system shown in FIG. 1. In 51, the at least one battery rack 1 is disconnected from the first DC bus 7 and is connected to the second DC bus 8. After connecting the at least one battery rack 1 to the second DC bus 8, the intra-battery equalization process is initiated in S2. In S3, during or after the intra-battery equalization process of S2, a power exchange takes place between the first DC bus 7 and the second DC bus 8 via the DC/DC converter 6 in order to achieve a balancing of the state of charge of the at least one battery rack 1 with the state of charge of the battery racks 1 connected to the first DC bus 7. After the state of charge has been balanced, the at least one battery rack 1 is disconnected from the second DC bus 8 in S4 and the at least one battery rack 1 is connected to the first DC bus 7.

The control circuit 11 shown in FIG. 1 can be designed and configured to carry out the method. For this purpose, it can, for example, communicate with the battery management systems 3, the DC/DC converter 6, the inverter bridge 9 and/or the switching circuit 5 via the communication bus 4 and control the aforementioned elements accordingly. To disconnect the transfer circuit or system 12 from the inverter bridge 9, the disconnecting switch 13 can be controlled by the control circuit 11. Alternatively, the switching state of the disconnector switch 13 can be transmitted to the control circuit 11.

What is claimed is:

1. A transfer circuit or system comprising:
a first DC bus configured to connect a plurality of battery racks to an inverter bridge for a first power exchange with an AC network;
a second DC bus connected to the first DC bus via a DC/DC converter, the DC/DC converter having a rated power at least a factor of 5 lower than a rated power of the inverter bridge; and
a control circuit configured to disconnect at least one battery rack of the plurality of battery racks from the first DC bus via a switching circuit in order to carry out an intra-battery equalization process, and to connect the at least one battery rack to the second DC bus,
wherein the control circuit, after connecting the at least one battery rack to the second DC bus, is configured to initiate the intra-battery equalization process for the at least one battery rack connected to the second DC bus, wherein during or after, or both during and after, the intra-battery equalization process a second power exchange takes place between the first DC bus and the second DC bus via the DC/DC converter in response to a command from the control circuit, in order to achieve a balancing of a state of charge of the at least one battery rack connected to the second DC bus with a state of charge of the battery racks connected to the first DC bus, and
wherein the control circuit, after the balancing of the state of charge, is configured to disconnect the at least one battery rack from the second DC bus via a switching circuit and connect the at least one battery rack to the first DC bus.

2. The transfer circuit or system according to claim 1, wherein the control circuit is configured to determine or receive a notification of a need of the at least one battery rack to perform the intra-battery equalization process.

3. A system comprising a plurality of battery racks and a transfer circuit or system according to claim 1, wherein the plurality of battery racks are converter-free battery racks and are connectable to the inverter bridge via the first DC bus for the first power exchange with the AC grid.

4. A method for performing an intra-battery equalization process in which a state of charge of cell sections of at least one battery rack in a system according to claim 3 is balanced, comprising:
disconnecting the at least one battery rack from the first DC bus and connecting the at least one battery rack to the second DC bus,
initiating the intra-battery equalization process with the at least one battery rack after connecting the at least one battery rack to the second DC bus,
during or after the intra-battery equalization process, initiating a second power exchange between the first DC bus and the second DC bus via the DC/DC converter, in order to achieve a balancing of a state of charge of the at least one battery rack with a state of charge of the battery racks connected to the first DC bus,
after the balancing of the state of charge, disconnecting the at least one battery rack from the second DC bus and connecting the at least one battery rack to the first DC bus.

5. The method according to claim 4, wherein the acts thereof are performed successively for each of the plurality of battery racks.

6. The method according to claim 4, wherein the second power exchange occurs at least temporarily during the intra-battery equalization process.

7. The method according to claim 4, wherein the second power exchange occurs at least intermittently such that the first power exchange of the system with an AC grid is supported.

8. The method according to claim 6, wherein the second power exchange is initiated based on the first power exchange via the inverter bridge, a completion of the balancing of the state of charge at a time of the completion of the intra-battery equalization process, or as soon as possible thereafter is enabled.

9. The method of claim 6, wherein the second power exchange is initiated at a time with regard to a completion time of the intra-battery equalization process such that a completion of a balancing of a state of charge due to the intra-battery equalization process is synchronized with a completion of the second power exchange.

10. The method according to claim 4, wherein the at least one battery rack independently detects a need to perform the intra-battery equalization process and communicates the detected need to a transfer circuit.

11. The method according to claim 10, wherein the communicated detected need comprises information about an urgency of performing the intra-battery equalization process.

12. The method according to claim 4, wherein the control unit of the transfer unit is configured to detect a suitable time for carrying out the intra-battery equalization process and initiates the intra-battery equalization process at this time.
